(19) United States
(12) Patent Application Publication
(10) Pub. No.: US 2016/0026375 A1
(43) Pub. Date: Jan. 28, 2016

(54) SHADELESS TOUCH HAND-HELD ELECTRONIC DEVICE, METHOD AND GRAPHICAL USER INTERFACE

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/707,709

(22) Filed: May 8, 2015

(30) Foreign Application Priority Data
Jul. 25, 2014 (CN) 201410361711.1

(51) Int. Cl. G06F 3/0484; G09G 5/00; G06F 3/041

(52) U.S. Cl. CPC G06F 3/04847; G06F 3/0416; G09G 5/003; G09G 2300/04

(57) ABSTRACT

A method is executed by a computer and executes, on a shadeless touch hand-held electronic device including a panel and a touch cover, following steps of: computing a trigger event of a plurality of detection points on the touch cover; comparing the trigger event with an activation judgment condition which is pre-stored in the shadeless touch hand-held electronic device; permitting the touch cover to receive at least an input action inputted by a user if the trigger event conforms to the activation judgment condition; and executing an operation corresponding to the input action. The operation includes enlarging and substantially centering a first box of a plurality of content boxes of a structured electronic document on the panel, and the enlargement includes extending the first box such that a width of the first box is substantially equal to that of the panel.

### CROSS REFERENCE TO RELATED APPLICATIONS

This Non-provisional application claims priority under 35 U.S.C. §119(a) on Patent Application No(s). 201410361711.1 filed in People's Republic of China on Jul. 25, 2014, the entire contents of which are hereby incorporated by reference.

### BACKGROUND OF THE INVENTION

1. Field of Invention

This invention relates to a hand-held electronic device, method and graphical user interface and, in particular, to a shadeless touch hand-held electronic device, method and graphical user interface.

2. Related Art

With the progress of technologies, various novel information devices are invented, such as cell phones, tablet computers, ultrabooks and GPS (Global Positioning System) navigation devices. Generally, a keyboard and mouse are commonly used to manipulate the information device for inputting information. Besides, the touch control technology currently also becomes a popular manipulation method for the information device and brings an intuitive operation. Accordingly, a touch display device using the touch control technology can provide a friendly and intuitive interface for the input operation, and therefore users of all ages can manipulate the touch display device by fingers or a stylus.

In a common and conventional hand-held electronic device with the touch function, the touch operations are all directly executed on the display panel. For example, in the “Portable Electronic Device, Method, and Graphical User Interface for Display Structured Electronic Documents” disclosed by the U.S. Pat. No. 7,864,163, the user mainly interacts with the graphical user interface (GUI) by the finger touch on the touch display panel. In some embodiments, the interaction may include the voice phone call, video conference, email, real-time information transmission, Blog, Facebook, photography, videography, web browsing, music playing, video playing, etc.

However, for the operation on the middle or small size panel, fingers will shade the user's view or the functional item displayed by the display panel, such that the user may erroneously touch, by finger, an undesired one of the items which are arranged in a high information content density on the display panel. In order to avoid the above condition, some electronic devices adopt a design where the touch operation area is separated from the display panel, such as disclosed by the U.S. Pat. No. 5,825,352 (Logitech).

However, such design will increase the volume of the electronic device and go against the tendency of the hand-held electronic device towards lightness, thinness and compactness, so as not to be easily carried out in the small-sized product such as tablet computer and cell phone. Moreover, the technique disclosed by the U.S. Pat. No. 5,825,352 (Logitech) also can't solve the view shading problem of the hand-held electronic device caused by the finger.

Besides, the frequent touch operation on the panel of the electronic device will scratch the panel. Moreover, in the common use of the hand-held electronic device with the touch function, one hand is used to hold the electronic device while the other hand is used to operate on the panel, so if just a single hand holds and operates the device at the same time, the touch operation just can be executed by the thumb and that is really inconvenient for the user.

Besides, when the user uses the hand-held electronic device under strong sunlight, the sunlight readability of the display panel is always a problem that can't be effectively solved. Since the user can't see the information displayed on the display panel, the two-hand operation is also ineffective and the information such as email or Facebook can't be respond promptly.

Furthermore, the touch panel needs to be configured with the rare earth transparent touch sensing such as ITO so as to be kept in high transparent display performance, but since the rare earth metal indium is unceasingly consumed, the cost of the product is getting higher and higher. Besides, the conductivity of the rare earth metal is worse than the normal metal, such that the detection sensitivity of the touch is limited. Therefore, using the rare earth transparent touch sensing layer in the touch panel is not a good course for the environmental resources and energy conservation. Moreover, the touch range of the finger is increased with the increased size of the panel, and this will cause the corresponding increment of the area of the touch sensing layer and the cost, and therefore the efficiency and convenience of the hand operation will be lowered down.

Therefore, a shadeless touch hand-held electronic device, method and graphical user interface can avoid the finger shade against user's view during the operation and the scratch on the panel. It can be also the convenience of the single-hand operation can be enhanced.

### SUMMARY OF THE INVENTION

An aspect of the invention is to provide a shadeless touch hand-held electronic device, method and graphical user interface whereby the finger can't shade the user's view during the operation and the scratch on the panel can be reduced and also the convenience of the single-hand operation can be enhanced.

Therefore, a method according to this invention is executed by a computer and executes, on a shadeless touch hand-held electronic device including a panel and a touch cover, following steps of: computing a trigger event of a plurality of detection points on the touch cover; comparing the trigger event with an activation judgment condition which is pre-stored in the shadeless touch hand-held electronic device; permitting the touch cover to receive at least an input action inputted by a user if the trigger event conforms to the activation judgment condition; and executing an operation corresponding to the input action. The operation includes enlarging and substantially centering a first box of a plurality of content boxes of a structured electronic document on the panel, and the enlargement includes extending the first box such that a width of the first box is substantially equal to that of the panel.

Moreover, a shadeless touch hand-held electronic device according to this invention comprises a panel, a touch cover, at least one processor, a memory and at least one program stored in the memory and configured to be executed by the processor. The program comprises: computing a trigger event of a plurality of detection points on the touch cover; comparing the trigger event with an activation judgment condition which is pre-stored in the shadeless touch hand-held electronic device; permitting the touch cover to receive at least an input action inputted by a user if the trigger event conforms to the activation judgment condition; and executing an operation corresponding to the input action. The operation comprises enlarging and substantially centering a first box of a plurality of content boxes of a structured electronic document on the panel, and the enlargement comprises extending the first box such that a width of the first box is substantially equal to that of the panel.

Furthermore, a graphical user interface of a shadeless touch hand-held electronic device which comprises a panel and a touch cover according to this invention comprises at least a part of a structured electronic document comprising a plurality of content boxes. A trigger event of a plurality of detection points on the touch cover is computed. The trigger event is compared with an activation judgment condition which is pre-stored in the shadeless touch hand-held electronic device. If the trigger event conforms to the activation judgment condition, the panel displays the structured electronic document and the touch cover is permitted to receive at least an input action inputted by a user. An operation corresponding to the input action is executed, the operation comprises enlarging and substantially centering a first box of the content boxes of the structured electronic document on the panel, and the enlargement comprises extending the first box such that a width of the first box is substantially equal to that of the panel.

In one embodiment, the input action comprises a first gesture executed on the touch cover for a displayed part of the structured electronic document and the operation further comprises steps of: detecting the first gesture; determining the first box of the content boxes on the position corresponding to the first gesture; and adjusting to enlarge the text size of the first box as equaling or exceeding a predetermined minimum text size of the panel.

In one embodiment, the operation further comprises steps of: detecting a second gesture executed on the touch cover for a second box which is outside of the first box; and centering the second box on the panel in response to the detected second gesture.

In one embodiment, the step of adjusting to enlarge the text size of the first box comprises steps of: determining a scaling factor which is used to enlarge the first box; dividing a predetermined minimum text size of the panel by the scaling factor to determine the minimum text size of the text of the first box; and at least increasing the text size of the text of the first box to the determined minimum text size if the text size of the text of the first box is less than the predetermined minimum text size.

In one embodiment, the method further comprises steps of: detecting a sliding gesture executed on the touch cover for the operation of the panel; and translating a displayed part of the structured electronic document on the panel in response to the detected sliding gesture.

In one embodiment, the trigger event comprises a trigger quantity distribution, a trigger time, a trigger frequency, a trigger morphology (it can also refer to trigger appearance) or a trigger location.

In one embodiment, the user operates the shadeless touch hand-held electronic device with a single hand, and the touch cover faces a light source or the panel's back faces the light source.

In one embodiment, the program further comprises: computing the trigger quantity distribution, trigger time, trigger frequency, trigger morphology or trigger location of the detection points at predetermined time intervals.

In one embodiment, the touch cover comprises: a cover and a touch sensing structure. The cover is disposed on the side of the hand-held electronic device against the panel and comprises a cover body. Partial or whole area of the touch sensing structure is disposed on the cover body. The touch sensing structure is electrically connected with the processor so that the user can operate the hand-held electronic device by the touch cover. The touch sensing structure comprises a plurality of detection points for producing an input position, the area of the touch sensing structure and the area of the panel have a ratio relationship, the processor converts the input position into the display position of the panel according to the ratio relationship, and the panel shows a notable sign at the display position.

In one embodiment, the touch sensing structure is disposed on an inner surface of the cover body facing the panel or on an outer surface of the cover body against the panel.

In one embodiment, the touch sensing structure comprises metal mesh, metal nanowires, transparent conducting film, carbon nanotube or graphene.

In one embodiment, the cover further comprises a sidewall extended from at least a part of the edge of the cover body, and the touch sensing structure is further extended to be disposed on at least one of the sidewall.

In one embodiment, the touch sensing structure comprises a first sensing layer, a second sensing layer and a capacitance detection unit. The first sensing layer comprises a plurality of first sensing lines disposed along a first direction. The second sensing layer is disposed opposite the first sensing layer and comprises a plurality of second sensing lines disposed along a second direction. The first sensing lines and the second sensing lines cross each other to form the detection points. The capacitance detection unit is coupled with the touch sensing structure to detect the change of the coupling capacitance between the first sensing lines and the second sensing lines.

In one embodiment, the first sensing layer or the second sensing layer is capable of a wireless power transmission.

In one embodiment, the shadeless touch hand-held electronic device further comprises an eyeball tracking module. The eyeball tracking module acquires an eyeball information which, corresponding to the panel, comprises a position information. The position information corresponds to the structured electronic document displayed by the panel.

In one embodiment, the shadeless touch hand-held electronic device further comprises a near field communication unit comprising a near field communication chip and an antenna. The near field communication chip is electrically connected with the control unit and the antenna is disposed on the cover or touch sensing structure.

In one embodiment, the user operates the shadeless touch hand-held electronic device with a single hand, and the touch cover faces a light source or the panel's back faces the light source.

In one embodiment, a circuit board, a battery or a memory card is disposed between the touch cover and the panel.

As mentioned above, in the shadeless touch hand-held electronic device, method and graphical user interface according to the invention, the user can execute the touch operation on the touch cover (or called smart cover) of the shadeless touch hand-held electronic device, so the finger of the user can't shade the view or the software object displayed by the panel, and also the touch for opening the link of the high information density image won't be erroneously executed. Besides, since the operation of the electronic device is executed on the touch cover, the panel scratch situation can be reduced. Furthermore, because the user can execute the touch operation on the touch cover, the user can use multiple fingers such as the forefinger and middle finger to operate the electronic device while using the same hand holding the device. In comparison with the conventional art where the user just can use the thumb to execute the operation while using the same hand holding the device, this invention can provide more manual efficiency and convenience and can realize a better user experience.

In one embodiment, the shadeless touch hand-held electronic device is used in the strong light environment such as the outdoor sunlight or indoor high-illuminance light, the user can operate the shadeless touch hand-held electronic device in a single hand while the touch cover faces the light source of the strong light environment (or the panel faces the user) and the panel's back faces the light source of the strong light environment, so the touch cover can block the light source. Thereby, the visibility can be enhanced and the user can continue the single-hand operation. Furthermore, the user can hold the device with a single hand and also execute the input operation with the forefinger and/or middle finger, so as to enhance the single-hand operation performance of the shadeless touch hand-held electronic device under the strong light source (such as the sunlight). Besides, in comparison with the conventional art where just the thumb can be used in the single-hand operation, the operation on the touch cover by the forefinger or middle finger can provide more flexibility and a new user experience about the single-hand holding and multi-finger touch operation.

Additionally, on the premise that the trigger quantity distribution, trigger time, trigger frequency, trigger morphology or trigger location conforms to the activation judgment condition, the hand-held electronic device just can permit the touch cover to receive at least an input action inputted by the user so as to correspondingly enlarge and substantially center the first box of the content boxes of the structured electronic document on the panel. Therefore, when other users want to operate the hand-held electronic device, they won't be permitted to operate the hand-held electronic device because the trigger event including the trigger quantity distribution, trigger time, trigger frequency, trigger morphology or trigger location doesn't conform to the activation judgment condition set by the original user, and therefore the information security of the hand-held electronic device can be enhanced.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing the operation of a shadeless touch hand-held electronic device of an embodiment of the invention;

FIG. 2 is a schematic block diagram of the shadeless touch hand-held electronic device in FIG. 1;

FIG. 3 is a schematic diagram of the shadeless touch hand-held electronic device of FIG. 1 in another viewing angle;

FIG. 4 is a schematic block diagram of the touch cover of an embodiment of the invention;

FIG. 5A is a schematic diagram showing the user uses just two fingers to operate the touch cover;

FIG. 5B is a schematic diagram showing the capacitance change caused by two fingers nonoverlapping each other after scanning the touch sensing structure;

FIG. 6 is a schematic diagram showing that the touch cover of the hand-held electronic device in FIG. 1 is triggered;

FIG. 7 is a schematic diagram showing another operation of the hand-held electronic device;

FIGS. 8A to 8E are schematic diagrams of the graphical user interfaces displayed by the panel of the hand-held electronic device of an embodiment of the invention; and

FIGS. 9A to 9C are schematic flowcharts of the process applied to the structured electronic document displayed on the shadeless touch hand-held electronic device.

### DETAILED DESCRIPTION OF THE INVENTION

The present invention will be apparent from the following detailed description, which proceeds with reference to the accompanying drawings, wherein the same references relate to the same elements.

This invention provides a design around the U.S. Pat. No. 5,825,352 (Logitech) to get rid of the patent infringement issue and also create a better user experience than the Logitech product using the above-mentioned technique.

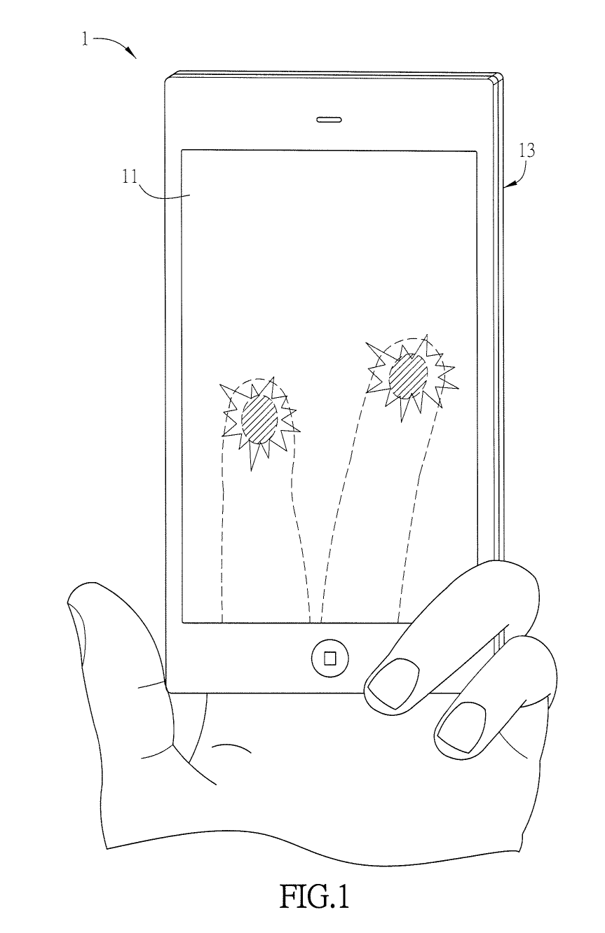

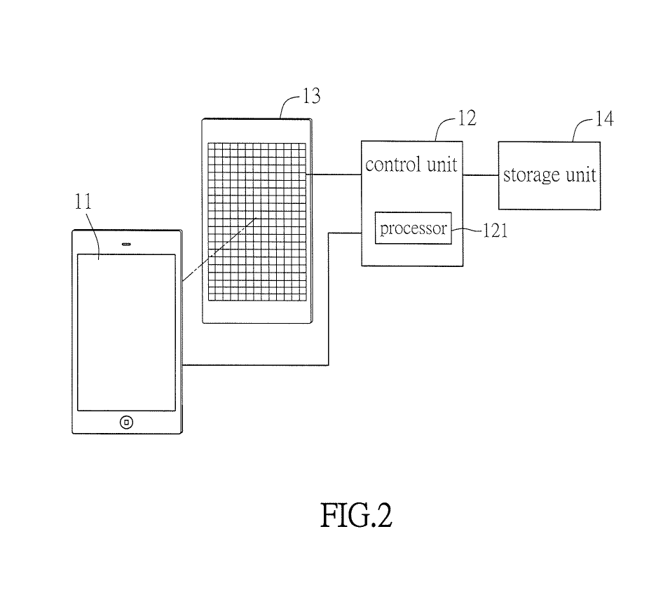

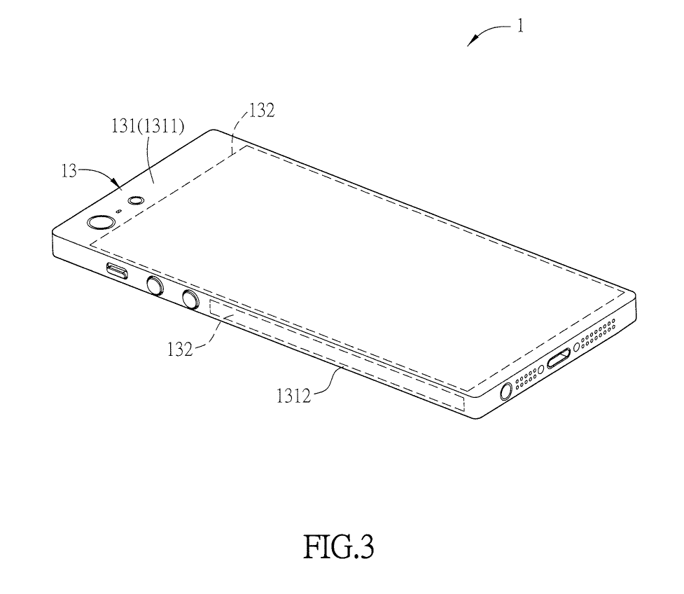

Referring to FIGS. 1 to 3, FIG. 1 is a schematic diagram showing the operation of a shadeless touch hand-held electronic device 1 of an embodiment of the invention, FIG. 2 is a schematic block diagram of the shadeless touch hand-held electronic device 1, and FIG. 3 is a schematic diagram of the shadeless touch hand-held electronic device 1 in another viewing angle.

The shadeless touch hand-held electronic device 1 (hereinafter abbreviated to hand-held electronic device 1) can be a smart phone, a tablet, a personal digital assistant (PDA), a global positioning system (GPS) device or another kind of hand-held electronic device, and herein the hand-held smart phone is illustrated as an example. Besides, the components of the hand-held electronic device 1 can be made by at least a hardware, software or firmware of the signal processing and/or integrated circuit or their any combination.

The hand-held electronic device 1 includes a panel 11, a control unit 12 and a touch cover 13. The hand-held electronic device 1 can further include a storage unit 14 and at least one program. The control unit 12 is electrically connected with the panel 11, touch cover 13 and storage unit 14, and can include at least one processor 121 (only single one processor 121 is shown in FIG. 2). The control unit 12 can access the program, data or information stored in the storage unit 14 and drive the panel 11 to display images.

The panel 11 is disposed on a side of the hand-held electronic device 1, such as the side of the hand-held electronic device 1 closer to the user's view. The panel 11 is, for example but not limited to, a liquid crystal display (LCD) panel, an organic light emitting diode (OLED) display panel, a touch display panel or an electrophoretic display panel. The panel 11 can not only display normal images but also provide the graphical user interface (GUI) for the user. The graphical user interface can show at least one figure (such as icon) on the panel 11 to exhibit any kind of the known software components.

The touch cover 13 includes a cover 131 and a touch sensing structure 132. The cover 131 is disposed on the side of the hand-held electronic device 1 opposite the panel 11 (i.e. the opposite side of the display surface). The cover 131 includes a cover body 1311 and a sidewall 1312 extended from at least a part of the edge of the cover body 1311. The touch sensing structure 132 is electrically connected with the processor 121 of the control unit 12, and at least a part of the area of the touch sensing structure 132 is disposed on the cover body 1311. In this embodiment, in addition to being disposed on the cover body 1311, the touch sensing structure 132 is extended to the sidewall 1312 of the two sides. That is, the touch sensing structure 132 is extended from the cover body 1311 to the two sides of the cover 131, so as to increase the operation area for the user. For more effectively using the width of the cover 131 for the disposition of the touch sensing structure 132, the width of the touch sensing structure 132 can be slightly less than that of the cover 131. For example, the width of the touch sensing structure 132 is about 90%˜95% that of the cover 131. In other embodiments, the touch sensing structure 132 can be only disposed on the cover body 1311. Moreover, a physical key (such as a sound control key) can be replaced by the touch sensing structure 312, but this invention is not limited thereto.

The wiring connecting to the touch sensing structure 132 can be gathered to a single side for the wiring outlet and then electrically connected with a circuit board, so as to enhance the design flexibility.

The touch sensing structure 132 provides a plurality of detection points for producing an input position. The area of the touch sensing structure 132 of the touch cover 13 is less than that of the panel 11 in this embodiment, and the areas have a ratio relationship, which will be used by the control unit 12 (at least one processor 121) converting the touch points of the touch cover 13 into the corresponding positions of the panel 11. Although the area of the touch sensing structure 132 of the touch cover 13 is less than that of the panel 11 in this embodiment, the area of the touch sensing structure 132 of the touch cover 13 may be equal to (even larger than) that of the panel 11 in another embodiment, which may occur when the touch sensing structure 132 is extended to the sidewall of the touch cover 13.

When the user executes the touch operation on the touch cover 13 by finger for example, the panel 11 can display the corresponding operation according to the user's operation gesture (or called the hand gesture), wherein the control unit 12 (at least one processor 121) will convert the input position of the touch sensing structure 132 into the display position of the panel 11 according to the ratio relationship, and the panel 11 will display a visible object (such as an icon) on the display position so that the user can interact with the graphical user interface displayed on the panel 11.

The user can execute the touch operation on the touch cover 13 by finger for example, and the panel 11 can display the corresponding operation according to the user's operation gesture (or called the hand gesture), and thereby the user can interact with the graphical user interface displayed on the panel 11. For example, when the user's finger slides on the touch cover 13, the panel 11 will display a corresponding icon (such as an arrow or hand shape) which slides correspondingly. Herein for example, the touch can be implemented by the user's finger or stylus contacting or nearly contacting the touch cover 13. Moreover, the interaction with the graphical user interface can be, for example, that the user touches the touch cover 13 by the finger to execute the click, enlargement or movement. For example, when the user's finger clicks the touch cover 13 at a position, the panel 11 will execute the item located at the corresponding position. Thereby, the item displayed by the panel 11 can be directly controlled and executed through the touch cover 13, and that means the shadeless touch can be achieved. The above-mentioned touch can include, for example, an operation gesture or hand gesture, such as a single tap or multiple taps, a single slide or multiple slides (such as a rightward, leftward, upward or downward slide), sequential clicks by multiple fingers, or simultaneous slide by multiple fingers. Besides, the operation of the hand-held electronic device 1 in response to the hand gesture can be determined by factory settings and/or according to the user's usage. Therefore, as shown in FIG. 1, the user can view the content displayed by the panel 11 through the front side of the hand-held electronic device 1 and execute the input operation through the touch cover 13 of the back side. Moreover, in one embodiment where the shadeless touch hand-held electronic device 1 is used in the strong light environment such as the outdoor sunlight or indoor high-illuminance light, the user can operate the shadeless touch hand-held electronic device 1 in a single hand while the touch cover 13 faces the light source of the strong light environment (the panel 11 faces the user) and the back of the panel 11 faces the light source of the strong light environment, so the touch cover 13 can block the light source. Thereby, the visibility can be enhanced and the user can continue the single-hand operation. Furthermore, the user can hold the device with a single hand and also execute the input operation with the forefinger and/or middle finger, so as to enhance the single-hand operation performance of the shadeless touch hand-held electronic device 1 under the strong light source (such as the sunlight). Besides, in comparison with the conventional art where just the thumb can be used in the single-hand operation, the operation on the touch cover 13 by the forefinger or middle finger can provide more flexibility and a new user experience about the single-hand holding and multi-finger touch operation.

Moreover, in addition to being disposed on the cover body 1311 and the sidewall 1312, the touch sensing structure 132 also can be disposed at other places of the hand-held electronic device 1 which won't cover the panel 11, such as the top surface and bottom surface, according to different requirements. Therefore, when the user executes the operation on the touch cover 13, as shown in FIG. 1, the display of the panel 11 won't be shaded by the fingers and the erroneous touch can be thus avoided. Besides, other advantages of providing the touch cover 13 for the user's touch operation include that the touch cover 13 needn't be made by the transparent touch sensing material (such as ITO) for matching the display performance of the panel 11, and therefore the material selection will be more flexible and the cost can be easily controlled.

The touch sensing structure 132 can be disposed on the inner surface of the cover 131 facing the panel 11 (i.e. the inside of the hand-held electronic device 1) or on the outer surface of the cover 131 against the panel 11 (i.e. the outside of the hand-held electronic device 1). Herein for example, the touch sensing structure 132 is a capacitive touch structure and formed on the inner surface of the cover 131 facing the panel 11, and is directly formed on the cover body 1311 and the two sidewalls 1312. In another embodiment where the touch sensing structure 13 is disposed on the outer surface of the cover 131 against the panel 11, a protection layer is required for protecting the touch sensing structure 13. To be noted, the material of the cover 131 can be glass or other materials, and the cover 131 is a part of the whole structure of the hand-held electronic device 1. In other words, the touch cover 13 is not an additional component (such as the protection cover of the electronic device), so if the touch cover 13 is separated from the hand-held electronic device 1, the inside components of the hand-held electronic device, such as battery or integrated circuit, can be seen. Moreover, the touch sensing structure 132 also can be disposed around some places of the cover 131 where the camera lens or flash light is disposed for example.

In one embodiment, a circuit board, a battery or a memory card can be disposed between the touch cover 13 and the panel 11. Besides, the touch sensing structure 132 can include a transmitter circuit and a receiver circuit (i.e. the so-called Tx and Rx, not shown), and the material thereof can be the conducting (film) layer (such as a transparent conducting layer, including indium tin oxide (ITO), indium zinc oxide (IZO), fluorine-doped tin oxide (FTO), Al-doped ZnO, Ga-doped ZnO for example), metal nanowires, graphene or metal mesh, but this invention is not limited thereto. If the metal mesh, metal nanowires or graphene is used as the material of the touch sensing structure 132, the Tx and Rx also can be used for the wireless information or power transmission (such as the Bluetooth communication or wireless charging).

If the touch sensing structure 132 is made by metal mesh, the metal texture effect can be exhibited on the appearance when the touch sensing structure 132 is disposed on the outer surface (not the display surface) of the cover 131. In this case, therefore, the metal cover can be omitted in the material selection and the cost can be further saved (because the metal cover is made by a more complicated process).

In one embodiment, the hand-held electronic device 1 can further include another touch sensing structure (not shown), which can be disposed on the panel 11 so that the panel 11 becomes a touch display panel. Therefore, the user can execute the shadeless touch operation on the cover 131, and also can use another touch sensing structure for the interaction with the device. Accordingly, the user can choose to execute the shadeless touch operation on the cover 131, or choose to operate the hand-held electronic device 1 directly on the touch display panel, or choose to operate the hand-held electronic device 1 on the cover 131 and the touch display panel at the same time.

As shown in FIG. 2, the control unit 12 is disposed on the circuit board which is disposed inside the hand-held electronic device 1 and can be composed of at least a processor 121, but this invention is not limited thereto. The control unit 12 can control not only the content displayed by the panel 11 but also the operation of the touch cover 13. The storage unit 14 is a storing medium of the hand-held electronic device 1, and can be the memory inside the hand-held electronic device 1 or outside the hand-held electronic device 1 (such as the cloud memory or cloud storage), but this invention is not limited thereto. The storage unit 14 can include, for example, ROM, RAM, flash, field-programmable gate array (FPGA) or other kinds of memory. Besides, one or more programs can be stored in the storage unit 14 and can be executed by one or more processors 121. The content of the at least one program can include the instruction for displaying at least a part of a structured electronic document including a plurality of content boxes on the panel 11, the instruction for detecting the first gesture that is executed at a position on the touch cover 13 for the operation of the structured electronic document, the instruction for determining the first box of the content boxes at the position of the first gesture, the instruction for enlarging and substantially centering the first box on the panel 11, the instruction for detecting the second gesture that is executed on the touch cover 13 and to the second box which is outside the first box when the first box is enlarged, and the instruction for substantially centering the second box on the panel 11 in response to the detected second gesture. The related illustration will be given later. Furthermore, the storage unit 14 also can store the operation system, application programs, data processing programs and electronic data of various formats. The operation system is the program managing the computer hardware and software resources. The application program can be a word processing program, email program or others. In this embodiment, the control unit 12 includes a central processing unit (CPU) for example to execute the programs.

In one embodiment, the software stored in the storage unit 14 can include, for example, the operation system, communication module (or instruction set), contact/motion module (or instruction set), graphics module (or instruction set), text input module (or instruction set), GPS module (or instruction set) or application programs (or instruction set). The operation system includes the task of controlling and managing the normal system. The communication module can communicate with other devices through at least a connection port (such as USB) and include any kind of software to process the received data. The contact/motion module can detect the contact executed on the touch cover 13 and other touch sensitive components (such as the touch board or other touch panels). Besides, the contact/motion module also can include any kind of software to execute the operation related to the touch detection. The graphics module includes any kind of software to show and display figures on the panel 11. The text input module which can serve as a component of the graphics module can provide a software keyboard for the text input of the application program (such as contacting a person, emailing, using web browser or other application programs requiring the text input). The GPS module determines the device's position and provides the position information for the application program. The storage unit 14 can store the above-mentioned modules or instruction sets and also can store other modules or instruction sets which are not mentioned above.

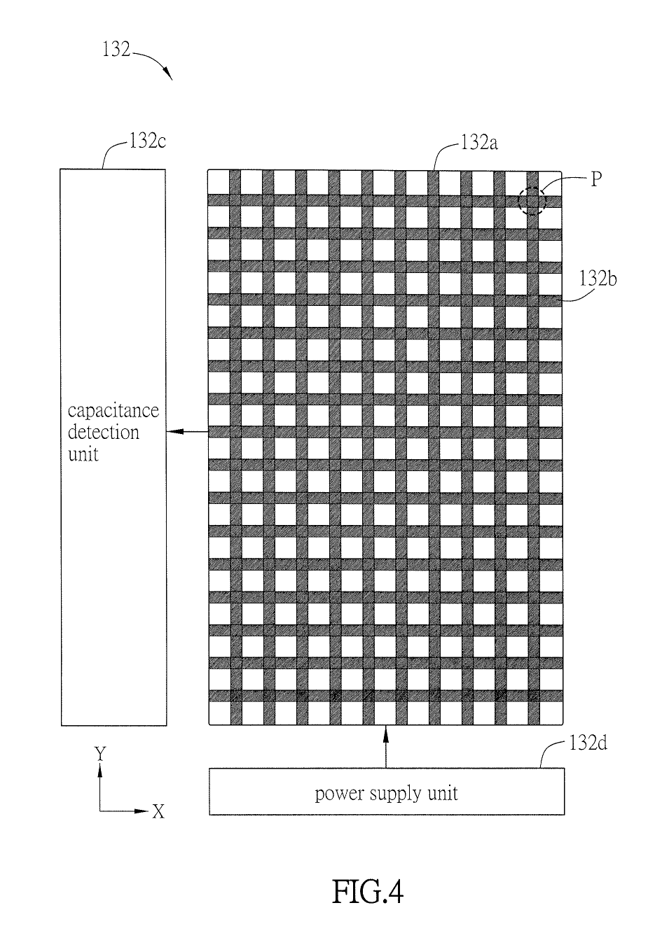

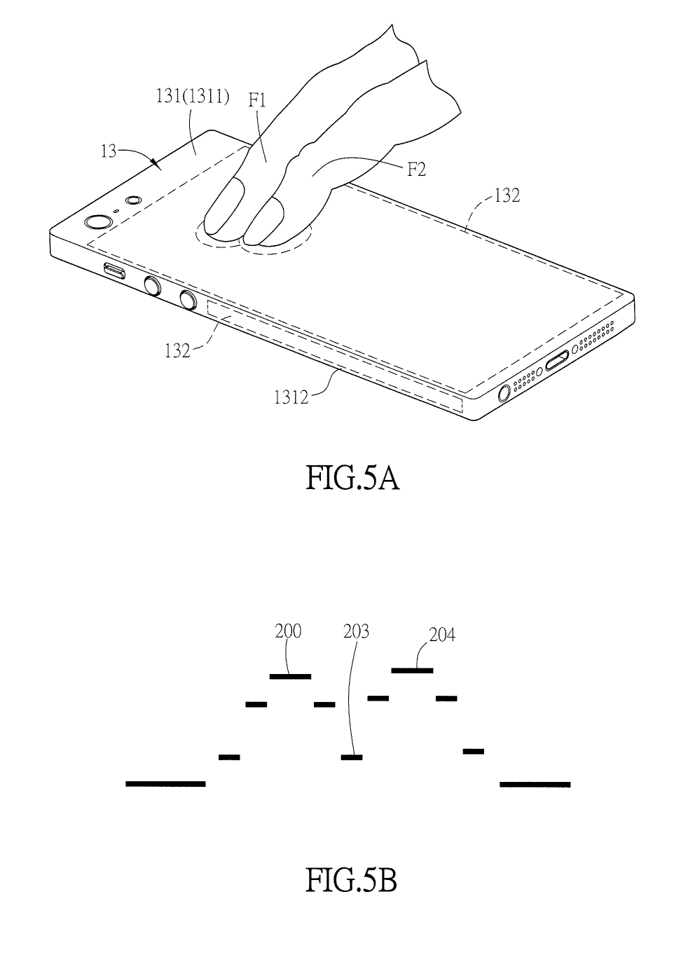

Then, referring to FIGS. 4 and 5A, FIG. 4 is a schematic block diagram of the touch cover of an embodiment of the invention and FIG. 5A is a schematic diagram showing the user uses just two fingers to operate the touch cover.

The touch sensing structure 132 of this embodiment can include a first sensing layer 132a, a second sensing layer 132b, a capacitance detection unit 132c and a power supply unit 132d.

The first sensing layer 132a and the second sensing layer 132b are electrically connected with the capacitance detection unit 132c through a circuit. The first sensing layer 132a has a plurality of first sensing lines which are spaced along the first direction X (such as the horizontal direction). The second sensing layer 132b is disposed opposite the first sensing layer 132a and has a plurality of second sensing lines which are spaced along the second direction Y (such as the vertical direction). The first sensing layer 132a and the second sensing layer 132b are spatially separated from each other. In physical, the first sensing layer 132a and the second sensing layer 132b are located on the different planes (the first sensing layer 132a and the second sensing layer 132b can be electrically insulated from each other by an insulating layer). Moreover, the first sensing lines and the second sensing lines cross each other to form a plurality of detection points P. The power supply unit 132d can send voltage signals to the second sensing lines. Accordingly, because the first sensing lines and the second sensing lines are close to each other and they are all conductors, each of the overlaps (i.e. the detection points P) between the first sensing lines and the second sensing lines has a coupling capacitance. To be noted, in this embodiment, the first sensing layer 132a and the second sensing layer 132b are disposed on the inner surface of the cover 131 facing the panel 11, so an insulating layer (not shown) is required between the first sensing layer 132a and the second sensing layer 132b for their electrical insulation. However, in other embodiments, the first sensing layer 132a is disposed on the inner surface of the cover 131 facing the panel 11 while the second sensing layer 132b is disposed on the outer surface of the cover 131 against the panel 11 (and vice versa), the cover 131 disposed between them can act as the material for their insulation and the insulating layer here is unnecessary. Besides, in one embodiment, the first sensing layer 132a or the second sensing layer 132b can be applied to the wireless power transmission (such as the wireless charging).

The capacitance detection unit 132c is electrically connected with the first sensing lines and the second sensing lines so as to detect the change of the coupling capacitance therebetween to provide the touch signal, and the touch signal can be transmitted to the control unit 12 so that the control unit 12 can execute the judgment or analysis to determine the selected object and the corresponding operation. For example, when the user's finger touches or nearly contacts a certain detection point P, the finger will change the charge coupling between the first sensing line and the second sensing line at the detection point P so as to change the capacitance of the detection point P. By the capacitance detection unit 132c detecting the change of the coupling capacitance between the first sensing line and the second sensing line, the touched position by the user's finger can be determined.

The capacitance detection unit 132c can include at least one sensor IC, which is used to detect the capacitance of each detection point P, convert the analog capacitance signal into the digital capacitance signal and then transmit the digital capacitance signal to the control unit 12 (not shown in FIG. 4) electrically connected with the capacitance detection unit 132c.

In other embodiments, at least a filter can be disposed between the first sensing lines and the capacitance detection unit 132c and can be formed by an inverting amplifier circuit for example. The filter can eliminate the parasitic capacitance of the touch sensing structure, which comes from, for example, the capacitance effect between the first sensing lines, between the second sensing lines or between the sensing lines and the grounding level. In short, the filter can prevent the signal inputted to the capacitance detection unit 132c from being affected by the capacitance except the capacitance at the detection point P.

In other embodiments, for example, the touch sensing structure may be a single-layered electrode structure. For example, the touch sensing structure may include a plurality of sensing pads which are formed simultaneously, and the sensing pads may be in the form of a single-layered structure. The sensing pads may be a transparent conducting layer or a metal mesh. The shape of the sensing pad includes, for example but is not limited to, a triangle or a diamond shape, as long as they can help to achieve touch sensing operations. Moreover, all sensing pads are unnecessary to have an identical shape.

The following is about the illustration of the touch sensing structure 132 of the touch cover 13 receiving the multi-finger input and generating the corresponding operation. Referring to FIGS. 5A and 5B, FIG. 5B is a schematic diagram showing the capacitance change caused by two fingers nonoverlapping each other after scanning the touch sensing structure 132.

FIG. 5A is a schematic diagram showing the multiple fingers of the user that contacting the touch cover 13, but the manner of the fingers contacting the touch cover 13 and the number of the fingers contacting the touch cover 13 are not limited thereto. Although this embodiment shows that the operation is executed on the cover body 1311 of the cover 131, the operation also may be executed on the cover body 1311 and the sidewall 1312 by multiple fingers in other embodiments. In other words, the operation shown in the figures is not meant to be construed in a limiting sense.

Herein for example, the middle finger F1 and the forefinger F2 are used in the operation. When the middle finger F1 and the forefinger F2 simultaneously contact the touch sensing structure 132 of the cover body 131, the capacitance detection unit 132c can detect a first peak value 200 and a second peak value 204. The first peak value 200 is the variation of the coupling capacitance corresponding to the middle finger F1 on the touch sensing structure 132, and the second peak value 204 is the variation of the coupling capacitance corresponding to the forefinger F2 on the touch sensing structure 132. Between the first peak value 200 and the second peak value 204 is a trough value 203, which is correspondingly generated by the interval between the two fingers. Therefore, by detecting the time difference between the occurrences of the first peak value 200 and second peak value 204 of the variation of the coupling capacitance or detecting the synchronous or relative motion between the fingers, the finger input gesture of the user can be determined, and the resulted finger touch signal can be transmitted to the control unit 12 for the corresponding operation. Those skilled in the art should comprehend that if the number of the fingers used in the operation is increased, the numbers of the peak value and tough value between the peaks and the applicability can be correspondingly increased. Accordingly, by the sequential or simultaneous touch or motion of the multiple fingers on the touch sensing structure 132, various operations can be executed on the touch cover 13, and the user's view can be prevented from being shaded by the fingers during the operation.

Moreover, although the trough value 203 shown in FIG. 5B is a nonzero variation of the coupling capacitance, the tough value 203 also may be zero in other embodiments, and the trough value 203 will be varied with the different interval between the adjacent fingers.

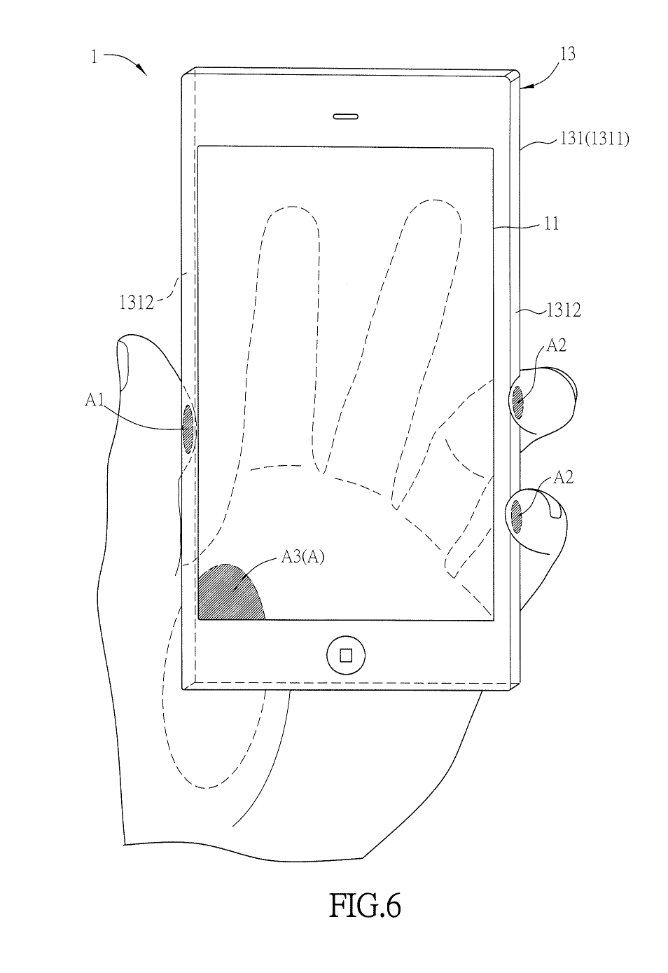

Referring to FIG. 6, FIG. 6 is a schematic diagram showing that the touch cover 13 of the hand-held electronic device 1 in FIG. 1 is triggered. The touch sensing structure 132 is not shown in FIG. 6.

In physical, when the user operates the hand-held electronic device 1, the holding usage of the user can be preset, and the control unit 13 can analyze the trigger event that is made by triggering the detection points from the user when operating the setting interface. The trigger event includes the trigger quantity distribution, trigger time, trigger frequency, trigger morphology or trigger location, and can be defined as the activation judgment condition and stored in the storage unit 14. In other words, the holding position or usage of the user operating the hand-held electronic device 1 can be defined as the activation judgment condition. For example, as shown in FIG. 6, when the user holds the hand-held electronic device 1, the control unit 13 can analyze the triggered detection point P at the holding position and define the region where the number of the adjacent triggered detection point P is larger than a predetermined value as a triggered area A. In this embodiment, according to the trigger quantity distribution of the detection point P, one of the sidewalls 1312 has a trigger area A1, the other sidewall 1312 has two trigger areas A2, and the cover body 1311 has a trigger area A3. In other words, in this embodiment, the trigger quantity distribution and the trigger location indicate the quantity and location of each trigger area, respectively, and the trigger morphology indicates the shape or appearance of each trigger area A, i.e. the shapes or appearance of the trigger areas A1, A2 and A3. Moreover, the trigger frequency indicates the click frequency at a certain location, and the trigger time indicates that the holding time exceeds a certain time or is related to the user's living habit.

After the setting is accomplished, the control unit 12 will compute the trigger quantity distribution, trigger time, trigger frequency, trigger morphology or trigger location of the detection points on the touch cover 13 at predetermined time intervals. Therefore, when the user's finger touches the touch cover 13, the control unit 13 can compute the trigger quantity distribution, trigger time, trigger frequency, trigger morphology or trigger location of the triggered detection point after receiving the touch signal, and can compare the obtained trigger quantity distribution, trigger time, trigger frequency, trigger morphology or trigger location with the activation judgment condition which is pre-stored in the hand-held electronic device 1.

If the trigger event (trigger quantity distribution, trigger time, trigger frequency, trigger morphology or trigger location) conforms to the activation judgment condition, the touch sensing structure 132 is permitted to receive at least an input action inputted by the user. In other words, on the premise that the trigger quantity distribution, trigger time, trigger frequency, trigger morphology or trigger location conforms to the activation judgment condition, the control unit 13 just can execute other actions to permit the touch sensing structure 132 to receive the user's input action, and then the hand-held electronic device 1 can execute the operation according to the input action. The operation includes enlarging and centering the first box of the content boxes of the structured electronic document on the panel 11, and the enlargement operation includes extending the first box such that the width of the first box is substantially equal to that of the panel 11. The related illustrated will be given later. Therefore, when other users want to hold and operate the hand-held electronic device 1, they can't operate the hand-held electronic device 1 because the trigger event including the trigger quantity distribution, trigger time, trigger frequency, trigger morphology or trigger location caused thereby doesn't conform to the activation judgment condition set by the original user, and therefore the security of the hand-held electronic device 1 can be enhanced. In other embodiments, the hand-held electronic device 1 can further include a fingerprint recognition unit (not shown), which is electrically connected with the control unit 12 and can recognize the fingerprint of at least one finger. Therefore, the user can store the fingerprint thereof in the storage unit 14 in advance, and when wanting to activate the hand-held electronic device 1, the user can touch, for example, a specific region of the cover body 1311 of the touch cover by finger, and the control unit 12 can compare the fingerprint in the specific region with the pre-stored fingerprint. If the fingerprints match each other, the hand-held electronic device 1 can be activated to receive the user's input action, and then the control unit 12 can generate the corresponding operation according to the input action. If the fingerprints don't match each other, the control unit 12 will judge that the user is not a permitted user so that the hand-held electronic device 1 can't be activated.

To be noted, if the trigger morphology exhibits a plurality of surface contacts, it will be directly judged not to conform to the activation judgment condition. The above multiple surface contacts denote two or more surfaces. In this embodiment, the surface contact denotes that the diameter of a single trigger area that the user contacts on the touch cover 13 or the longest distance from an edge of the contact to the other edge of the contact is 7 mm or more. The case of the multiple surface contacts is easily caused when the user just purely holds the hand-held electronic device 1 instead of touching or operating the hand-held electronic device 1, so the trigger event caused thereby is directly judged not to conform to the activation judgment condition.

Moreover, in the case of the trigger morphology of the trigger event exhibiting a single surface contact, the activation judgment can be made according to the position of the single surface contact. For example, when the position of a single surface contact is on the upper portion of the hand-held electronic device, it is also judged not to conform to the activation judgment condition. The above configuration is based on that if the user normally holds the hand-held electronic device and executes the touch operation on the touch cover by finger, the palm of the user may be located at the lower portion of the hand-held electronic device to form the trigger area of a surface contact instead of forming the trigger area of a surface contact at the upper portion. Besides, when the finger executing the touch operation at the upper portion contacts the touch cover to form a trigger area, the diameter of the trigger area or the longest distance from an edge of the contact to the other edge of the contact is often not larger than 7 mm. Therefore, when the position of a single surface contact is located on the upper portion of the hand-held electronic device, it is quite possible that the user may clean the cover or purely hold the hand-held electronic device instead of executing the touch operation. Herein, the upper portion or the lower portion can be defined according to the center of the cover or the center of the touch sensing structure and in the situation of the user operating the hand-held electronic device. The portion above the center is the upper portion while the portion below the center is the lower portion.

In other embodiments, the hand-held electronic device 1 can further include a palmprint recognition unit (not shown), which is electrically connected with the control unit 12 and can recognize at least a part of the palmprint of the user. Therefore, the user can store the palmprint thereof in the storage unit 14 in advance, and when wanting to activate the hand-held electronic device 1, the user can touch, for example, a specific region of the cover body 1311 of the touch cover 13 by finger, and the control unit 12 can compare the palmprint in the specific region with the pre-stored palmprint. If the palmprints match each other, the hand-held electronic device 1 can be activated to receive the user's input action. If the palmprints don't match each other, the control unit 12 will judge that the user is not a permitted user, such that the hand-held electronic device 1 is not activated. The above input action includes, for example, opening a webpage, reading the email content, executing APPs, etc.

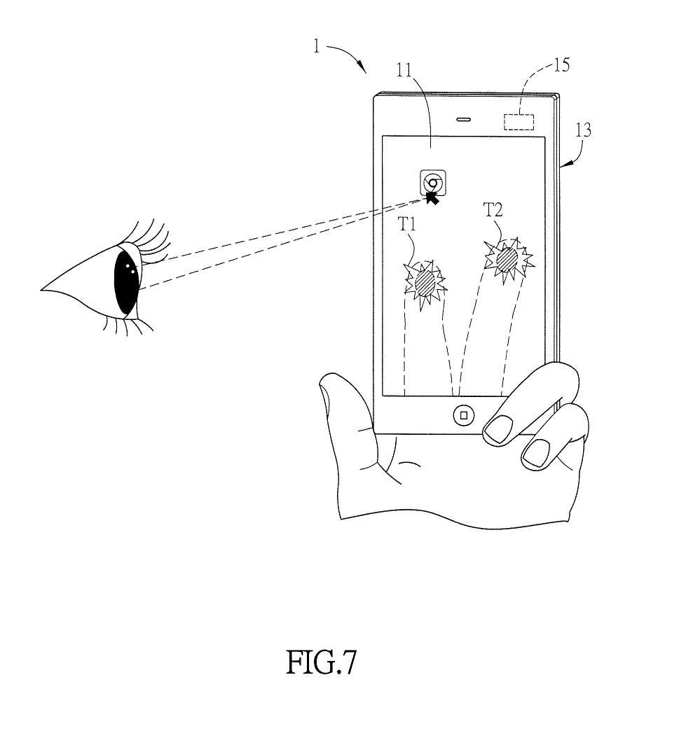

FIG. 7 is a schematic diagram showing another operation of the hand-held electronic device 1.

As shown in FIG. 7, the hand-held electronic device 1 can further include an eyeball tracking module 15, which is electrically connected with (not shown) the control unit 12. The eyeball tracking module 15 of this embodiment can be an eye tracking device, a camera, a video device or an infrared detecting device and can detect and acquire the eyeball information of the user. The eyeball information can be an eye image, eye coordinates or their combination for example. The eyeball information acquired by the eyeball tracking module 15, corresponding to the panel 11, contains a position information, and the position information will correspond to at least an object displayed by the panel 11. To be noted, the position information is unnecessary to be completely the same as the focus of the eyes of the user, and can be modified to provide the position of the object which is closest to the focus of the user's eyes. That is, for the convenience of the user selecting the object, the position information will be automatically modified to provide the position of the nearest object.

As shown in FIG. 6, the panel 11 can display an arrow for example at the position corresponding to the position information so that the user can know the position corresponding to the position information. When the eyeball information of the user is changed, the position information (arrow) on the panel 11 will be moved correspondingly.

As shown in FIGS. 4 to 7, the eyeball information acquired by the eyeball tracking module 15 working with the finger input detection will be illustrated as below. The all operation gestures (hand gestures) as below are the touch operation gestures implemented by the user's finger on the touch cover 13. Besides, the finger input detection of this embodiment can be applied to the above hand-held electronic device 1, but this invention is not limited thereto. The method of detecting the finger input includes the following steps. First, the eyeball information, such as the eye image, eye coordinates or their combination, can be acquired by the eyeball tracking module 15. Then, the eyeball information, corresponding to the panel 11, has the position information, and the position information can correspond to at least an object displayed by the panel 11. The object can be an icon for example, which corresponds to an application program. The position information of this embodiment can be correspondingly shifted to the position of the object which is closest to the position information.

Then, the touch sensing structure 132 is scanned, so as to detect the change of the coupling capacitances between the first sensing lines and the second sensing lines of the touch sensing structure 132 (i.e. the change of the coupling capacitance at the detection point P). When a finger touches the touch sensing structure 132 (through a click or contact), the coupling capacitance will be changed and a touch signal is thus generated, and the touch signal will be transmitted to the control unit 12. The control unit 12 of the hand-held electronic device 1 will, according to the touch signal, determine the selected object, i.e. the corresponding object of the position information (arrow). The object to be selected can be given a notable sign (such as a color change). In other embodiments, the notable sign also can be a prompt box, a shape change (such as a bigger shape), a flash of the selected object, or a displayed sign near the selected object.

The hand-held electronic device 1 will determine the selected object according to the touch signal and also execute the instruction corresponding to the object. In other words, when the touch sensing structure 132 detects the change of the coupling capacitance caused by, for example, a click or double clicks, the hand-held electronic device 1 will execute the application program corresponding to the object corresponding to the position information. For example, after a single click to select the browser shortcut icon, the browser will be executed.

Moreover, in the situation of the multi-finger input where the user uses another finger to touch the touch sensing structure 132 for example (at this time, the touch sensing structure 132 receives two touch signals T1, T2), the control unit 12 will analyze the two touch signals T1, T2 inputted at two different timings to give the corresponding operation such as moving the selected object. Accordingly, when two fingers continuously touch the touch sensing structure 132 with a movement, the object displayed by the panel 11 will exhibit a corresponding movement in response to the moving path of the two fingers. To be noted, this embodiment just illustrates the input of a single or multiple fingers and the corresponding operations, but those skilled in the art can develop many variations accordingly.

In one embodiment, the hand-held electronic device 1 can further include a near field communication unit (not shown), which includes a near field communication chip and an antenna. The near field communication chip is electrically connected with the control unit 12 (at least one processor 121), and the antenna can be disposed on the cover 131 or the touch sensing structure 132 for example, but this invention is not limited thereto. When the user wants to communicate with another electronic device through the near field communication (NFC), the hand-held electronic device 1 can be made closer to another electronic device capable of the near field communication function to receive or transmit data through the antenna and the near field communication chip.

The all operation gestures (hand gestures) as below are the touch operation gestures implemented by the user's finger or stylus on the touch cover 13. The finger operation can bring more convenience, but the user's finger is not shown in the following figures.

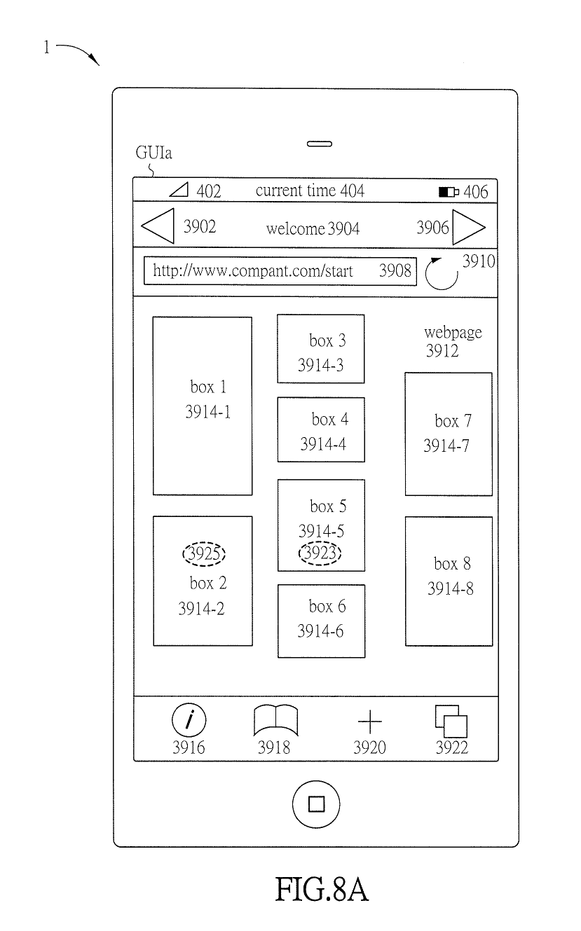

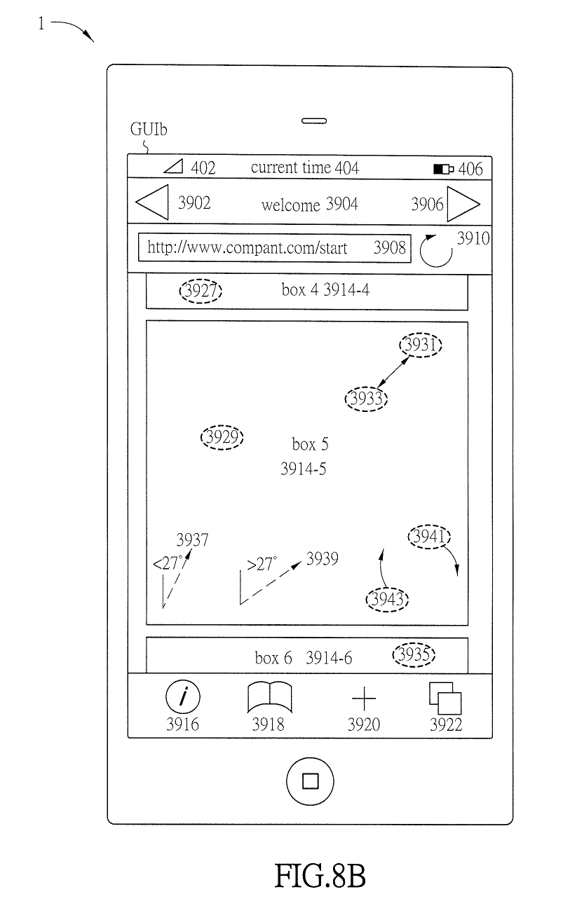

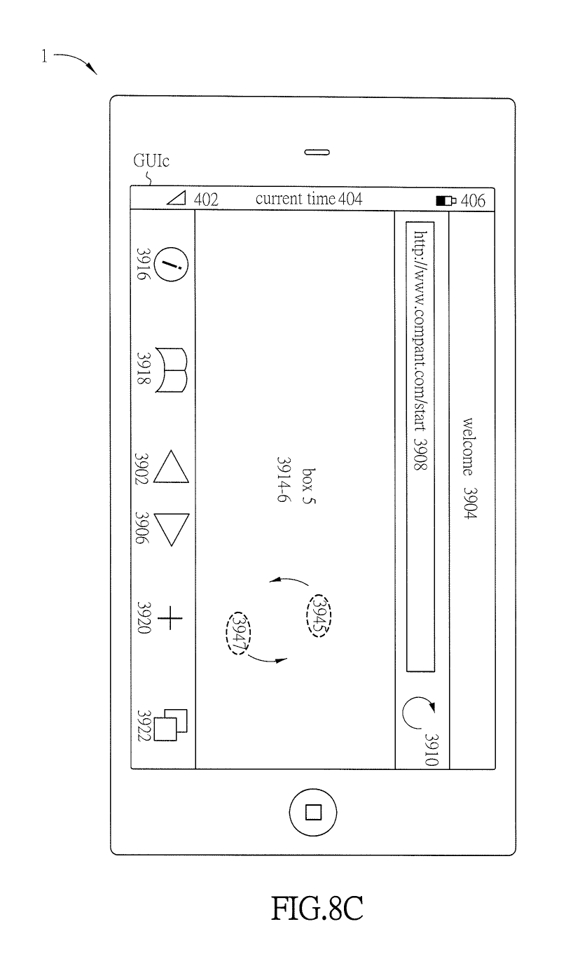

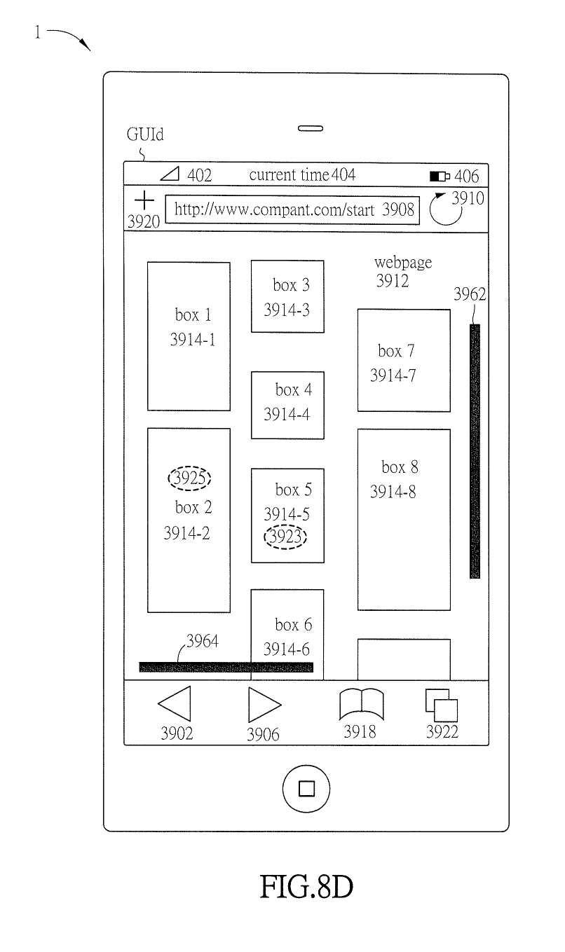

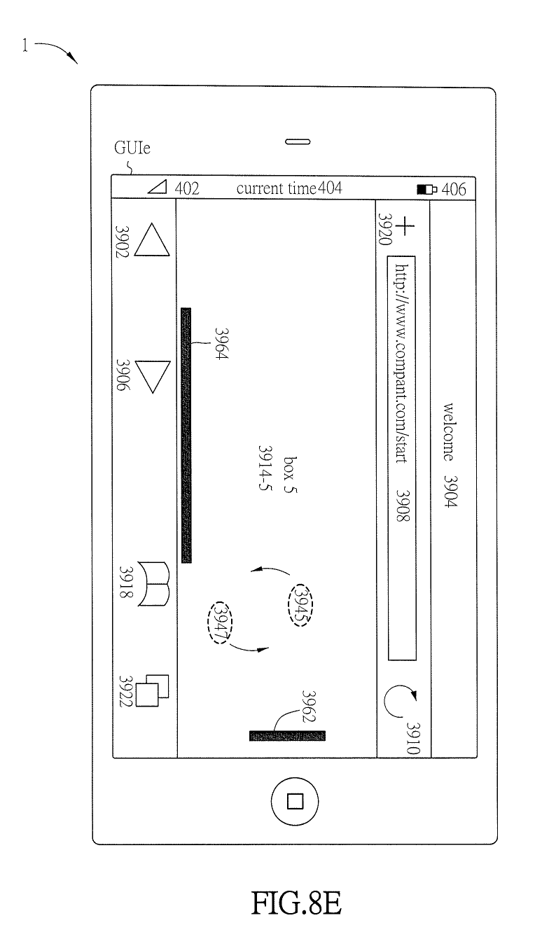

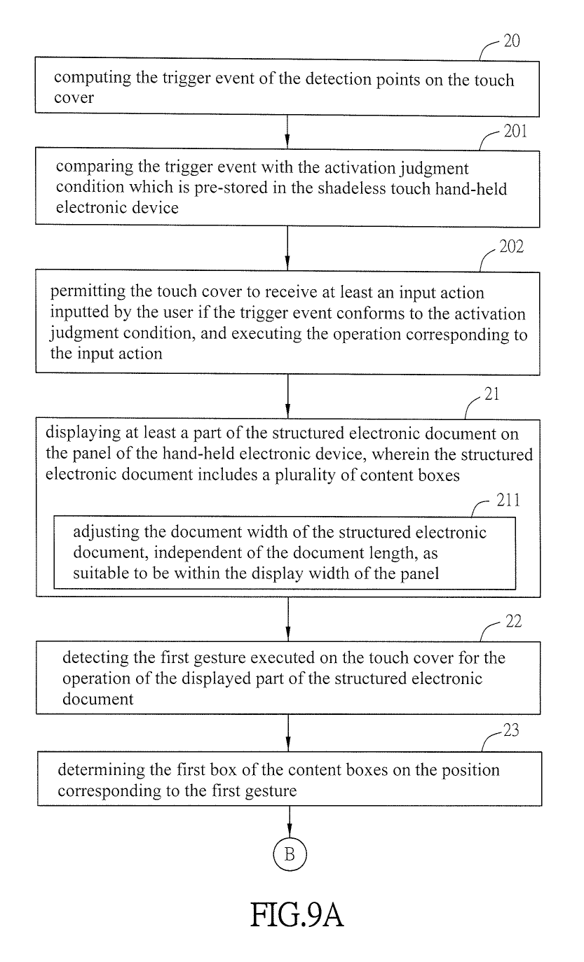

Refer to FIGS. 8A to 8E, which are schematic diagrams of the graphical user interfaces such as GUIa to GUIe displayed by the panel 11 of the hand-held electronic device 1. The graphical user interfaces such as GUIa to GUIe are used by the browser to show the structured electronic document (webpage). In different embodiments, the graphical user interfaces such as GUIa to GUIe also can be other kinds of interfaces, such as a multimedia play interface.

The graphical user interface displayed by the panel 11 can include at least a figure, and the user can contact the touch cover 13 by at least a finger or stylus to operate the figure displayed by the panel 11. The above contact can include an operation gesture or hand gesture, such as a single tap or multiple taps, a single slide or multiple slides (such as a rightward, leftward, upward or downward slide). Moreover, the panel 11 can display an arrow or a finger (not shown), and when the user operates on the touch cover 13 such as moving the finger, the arrow or finger displayed by the panel 11 can move correspondingly. Thereby, the structured electronic document displayed on the panel 11 can be directly controlled by the touch cover 13, and the shadeless touch can be achieved.

In one embodiment, the graphical user interfaces such as GUIa to GUIe can include, for example but are not limited to, the following elements or their subset or the hyperlink, such as (in FIG. 8A) the signal intensity indicator 402 for the wireless communication; the current time 404; the battery condition indicator 406; the previous page icon 3902, which is activated to display the previous webpage; the webpage name 3904; the next page icon 3906, which is activated to display the next webpage; the URL (uniform resource locator) input box 3908, which is used to input the URL of the webpage; the refresh icon 3910, which is activated to refresh the webpage; the webpage 3912 or another structured document, which is composed of the text content and other graphical boxes 3914 (displaying the text or graphical content and including the boxes 3914-1˜3914-6); the setting icon 3916, which is activated to display the setting menu of the browser; the bookmark icon 3918, which is activated to display the bookmark setting menu of the browser; the bookmark adding icon 3920, which is activated to display the graphical user interface for adding the bookmark; the new window icon 3922, which is activated to start the graphical user interface for adding a new window to the browser; the vertical scroll bar 3962 (such as shown in FIG. 8D or 8E) used for the webpage 3912 or another structured electronic document to help the user understand which part of the webpage 3912 or another structured electronic document is currently displayed; and the horizontal scroll bar 3964 (such as FIG. 8D or 8E) used for the webpage 3912 or another structured electronic document to help the user understand which part of the webpage 3912 or another structured electronic document is currently displayed. In addition to the above illustrated icons, there may be other icons shown to represent other operational functions, and there may be different icons in the different graphical user interfaces, and the related illustration is omitted here for conciseness.

In some embodiments, in response to the operation gesture (the same as the predetermined gesture) (such as a single tap gesture or double tap gesture) which is executed to the box 3914 of the panel 11 by the user, the box is enlarged and centered (or substantially centered) on the webpage display. For example, when the user executes the single tap gesture 3923 on the touch cover 13 for the displayed part (such as the box 3914-5 in FIG. 8A) of the structured electronic document, the box 3914-5 can be enlarged and centered on the panel 11, such as shown as the graphical user interface in FIG. 8B. Herein, the width of the box can be adjusted to fill the panel 11. In some embodiments, the width of the box can be adjusted as the edge of the box is at a predetermined distance from the edge of the panel 11 and the box is filled in the panel 11. In some embodiments, the zoom animation of the box can be displayed during the enlargement of the box. In FIG. 8A, in response to the tap gesture 3925 at the box 3914-2, the box 3914-2 can be enlarged with a zoom animation and can be moved to the center of the panel 11 in a two-dimensional manner (not shown in FIG. 8A). The hand-held electronic device 1 can analyze the render tree of the webpage 3912 to determine which box 3914 of the webpage is operated.

In some embodiments, in response to the same gesture (the same as the predetermined gesture) (such as the single tap gesture or double tap gesture) as the gesture used for enlarging and centering box 3914 executed by the user, the enlargement and/or substantial centering can be reversed. For example, as shown in FIG. 8B, in response to the single tap gesture 3929 on the box 3914-5, the webpage figure can be reduced in size and moved back to the box 3914-5 in FIG. 8A. In some embodiments, in response to the predetermined gesture (such as the single tap gesture or double tap gesture) executed on the enlarged but not centered box 3914 by the user, the box will be centered (or substantially centered) on the webpage display. For example, as shown in FIG. 8B, in response to the single tap gesture 3927 on the box 3914-4, the box 3914-4 can be enlarged and centered (or substantially centered) on the webpage display. Likewise, in FIG. 8B, in response to the single tap gesture 3935 on the box 3914-6, the box 3914-6 also can be enlarged and centered (or substantially centered) on the webpage display. Therefore, for the enlarged box of the webpage display, in response to the predetermined gesture executed on the touch cover 13, the hand-held electronic device 1 can visually display the box (enlarged and substantially centered) that the user wants to see. However, in different environments, the same operation gesture also can start different actions, such as (1) combining the zoom and/or enlargement and rolling when the webpage size is reduced and (2) reversing the enlargement and/or centering if the box has been centered and enlarged.

In some embodiments, as shown in FIG. 8B, in response to the multi-finger open/close gestures 3931, 3933 (in the case of open gesture for example) executed on the touch cover 13 by the user, the webpage can be enlarged. Contrarily, in response to the multi-finger open/close gestures (in the case of close gesture for example) executed on the touch cover 13 by the user, the webpage can be reduced in size. Moreover, in some embodiments, in response to the upward (or downward) sliding gesture of the user, the webpage (or other electronic documents) can roll upward (or downward) vertically in one dimension. For example, in response to the upward sliding gesture 3937 of the user within a predetermined angle range from the verticality (in FIG. 8B, less than 27° for example), the webpage can roll upward vertically in one dimension.

Contrarily, in some embodiments, in response to the sliding gesture without the predetermined angle range from the verticality, the webpage can roll in two dimensions (for example, the webpage moves in a vertical direction and a horizontal direction at the same time). For example, in response to the upward sliding gesture 3939 of the user without the predetermined angle range from the verticality (in FIG. 8B, larger than 27° for example), the webpage can roll in two dimensions along the direction of the sliding gesture 3939.

In some embodiments, as shown in FIG. 8B, in response to the rotation gestures 3941, 3943 of the user, the webpage can be strictly rotated for 90 degrees (such as the graphical user interface GUIc in FIG. 8C) to facilitate the transverse view of the displayed content, even if the rotational degree of the rotation gestures 3941, 3943 is not equal to 90 degrees. Likewise, in response to the rotation gestures 3945, 3947 of the user, the webpage can be strictly rotated for 90 degrees (such as the graphical user interface GUIb in FIG. 8B) to facilitate the longitudinal view of the displayed content, even if the rotational degree of the rotation gestures 3945, 3947 is not equal to 90 degrees. Therefore, in response to the inaccurate operation gesture executed by the user on the touch cover 13, the shadeless touch hand-held electronic device also can exhibit an accurate movement and operation of the selected figure. That is, even though the user's input is not accurate, the shadeless touch hand-held electronic device 1 still can exhibit the operation that the user desires. Moreover, to be noted, the gestures described in the graphical user interface GUIb (FIG. 8B) exhibiting the longitudinal view can be applied to the graphical user interface exhibiting the transverse view, such as the graphical user interface GUIc in FIG. 8C, and therefore the user can choose a preferred way to operate the webpage browsing.

Accordingly, the graphical user interface of the shadeless touch hand-held electronic device 1 can include at least a part of the structured electronic document, and the structured electronic document can contain a plurality of content boxes. The hand-held electronic device 1 can respond to the detected first gesture executed on the touch cover 13 for the operation of the displayed part of the structured electronic document and determine the first box of the content boxes located at the position corresponding to the first gesture, and then the first box of the structured electronic document will be enlarged and moved, so that the first box is substantially at the center of the panel 11. When the first box is enlarged, the second gesture executed on the touch cover 13 for the operation of the second box outside the first box can be detected, and the hand-held electronic device 1 also can respond to the detected second gesture. Then, the structured electronic document is moved, so that the second box is substantially disposed at the center of the panel 11. Furthermore, the panel 11 displays the corresponding operation according to the first gesture or second gesture. In some embodiments, the panel 11 can have a rectangular shape and include a short axis and a long axis. When the structured electronic document is seen in a longitudinal view, the display width corresponds to the short axis, and when the structured electronic document is seen in a transverse view, the display width can correspond to the long axis. Besides, the first gesture or second gesture can be generated by the finger or stylus. The first gesture or second gesture is a double tap of a single finger, or a double tap of two fingers, or a single tap of a single finger, or a single tap of two fingers.

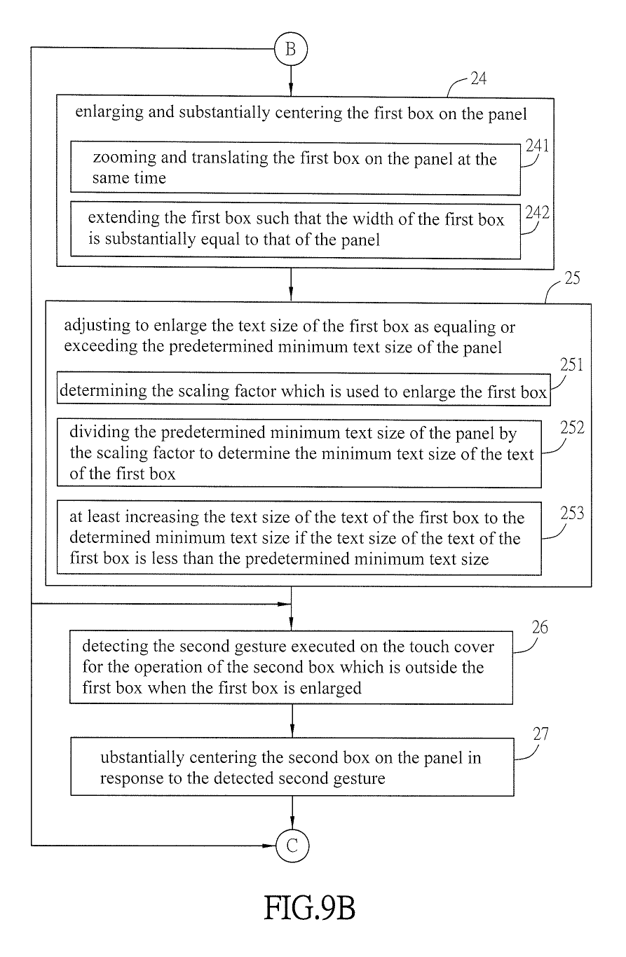

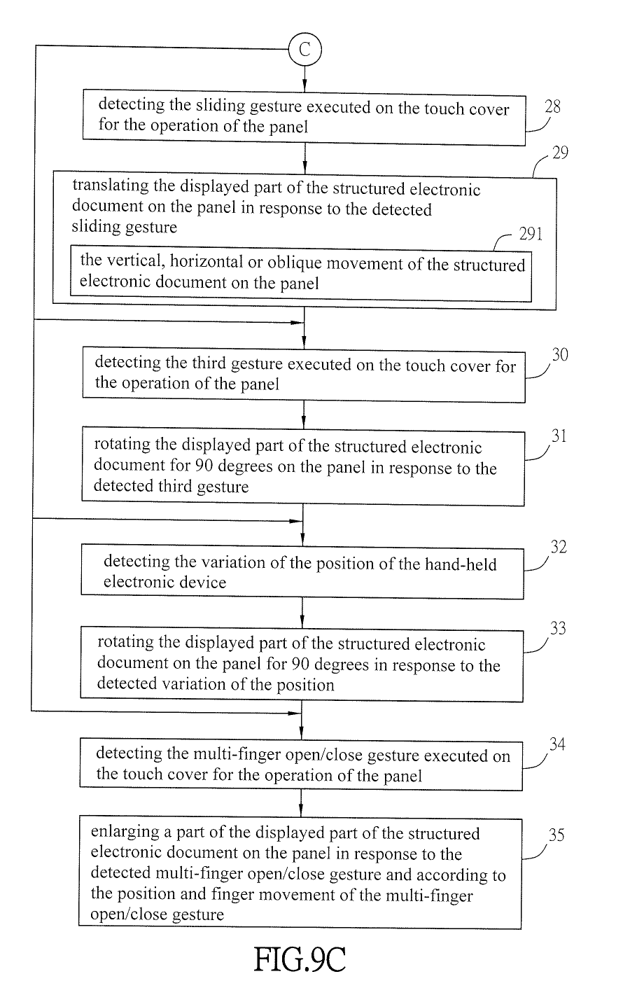

Referring to FIGS. 8A to 8E with FIGS. 9A to 9C, FIGS. 9A to 9C are schematic flowcharts of the process applied to the structured electronic document displayed on the shadeless touch hand-held electronic device 1.

As shown in FIG. 9A, the process includes computing the trigger event of the detection points on the touch cover 13 (step 20). The trigger event includes trigger quantity distribution, trigger time, trigger frequency, trigger morphology or trigger location. Herein, the control unit 12 is used to compute the trigger quantity distribution, trigger time, trigger frequency, trigger morphology or trigger location of the detection points at predetermined time intervals. Then, the process includes comparing the trigger event with the activation judgment condition which is pre-stored in the shadeless touch hand-held electronic device 1 (step 201). Then, if the trigger event conforms to the activation judgment condition, the touch cover 13 is permitted to receive at least an input action inputted by the user, and the process includes executing the operation corresponding to the input action (step 202, the detailed illustration can be comprehended by referring to the above embodiments).

The operation can include displaying at least a part of the structured electronic document on the panel 11 of the hand-held electronic device 1, wherein the structured electronic document includes a plurality of content boxes (such as the box 3914 including the boxes 3914-1˜3914-8) (step 21). The structured electronic document is a webpage for example (such as the webpage 3912 in FIG. 8A), and the content boxes can be defined by the style expression language, which can be a Cascading style expression language. Moreover, the structured electronic document can be of HTML (HyperText Markup Language) or XML (eXtensible Markup Language). In some embodiments, at least a part of the structured electronic document can be adjusted in the document width, independent of the document length, so as to be suitable to be within the display width of the panel 11 (step 211). The structured electronic document has a document width and a document length, and the panel 11 has a display width. At least a part of the structured electronic document can be adjusted in the document width, independent of the document length, so as to be suitable to be within the display width of the panel 11. The panel 11 can have a rectangular shape and include a short axis and a long axis, which also can be called the minor axis and the major axis, respectively. When the structured electronic document is seen in a longitudinal view (such as FIG. 8B), the display width can correspond to the short axis, and when the structured electronic document is seen in a transverse view (such as FIG. 8C), the display width can correspond to the long axis. In some embodiments, before displaying at least a part of the structured electronic document, the frame, page margin and/or filling of the designated content boxes of the structured electronic document need to be determined and adjusted, so as to be displayed in the panel 11.

The process includes detecting the first gesture (such as the single tap gesture 3923 in FIG. 8A) executed on the touch cover 13 for the operation of the displayed part of the structured electronic document (step 22). The first gesture can be generated by the finger or stylus. In some embodiments, the first gesture can be a tap gesture, or a double tap of a single finger, or a double tap of two fingers, or a single tap of a single finger, or a single tap of two fingers.

The process includes determining the first box (such as the box 5 in FIG. 8A) of the content boxes on the position corresponding to the first gesture (step 23). In some embodiments, the structured electronic document includes a render tree having a plurality of related nodes, and the step of determining the first box on the position corresponding to the first gesture can include: traversing downward the render tree to determine the first node of the nodes corresponding to the detection position of the first gesture; traversing upward the render tree from the first node until the nearest parent node of the logical grouping including the content; and identifying the corresponding content nearest the parent node as the operated first box on the position corresponding to the first gesture. The above-mentioned logical grouping of the content can include the paragraph, figure, plugin or table, and the nearest parent node is the replaced embedded, or box, or embedded box, or embedded table.

The process includes enlarging and substantially centering the first box (such as the box 5, 3914-5) on the panel 11 (step 24). The enlargement and substantial centering include zooming and translating the first box on the panel 11 at the same time (step 241). Besides, the enlargement can include extending the first box such that the width of the first box is substantially equal to that of the panel 11 (step 242). In some embodiments, as shown in FIG. 9B, the process includes adjusting to enlarge the text size of the first box as equaling or exceeding the predetermined minimum text size of the panel 11 (step 25). The step of adjusting to enlarge the text size of the first box includes: determining the scaling factor which is used to enlarge the first box (step 251); dividing the predetermined minimum text size of the panel 11 by the scaling factor to determine the minimum text size of the text of the first box (step 252); and at least increasing the text size of the text of the first box to the determined minimum text size if the text size of the text of the first box is less than the predetermined minimum text size (step 253). The first box has a width before the enlargement and the panel 11 has a display width, and the scaling factor is the display width divided by the width of the first box before the enlargement. For example, if the predetermined minimum text size is the 18-point font and the scaling factor is determined as 2, the minimum text size of the text of the first box is equal to 9 (18/2). If the text of the first box is the 10-point font, the text size thereof needn't be enlarged (10>9). Once the scaling factor is used, the text will exhibit the 20-point font, which is larger than the predetermined minimum text size, i.e. 18-point font. However, if the text of the first box is 8-point font, the text will exhibit 16-point font due to the use of the scaling factor, and the 16-point font is less than the predetermined minimum text size, i.e. 18-point font. Accordingly, since 8 is smaller than 9, the text size is increased to at least 9-point font and the text can be shown by at least 18-point font after the application of the scaling factor. Moreover, in some embodiments, the adjustment of the size of the first box can occur during the box enlargement or after the box enlargement.

In some embodiments, another gesture executed on the touch cover 13 after the enlargement of the first box can be detected, and in response to the another gesture that is detected, the size of the displayed part of the structured electronic document is reduced (not shown). In some embodiments, the first box can be restored to the size before the enlargement. Moreover, in some embodiments, when the first box is enlarged, the process includes: detecting the second gesture (such as the gesture 3927 or 3935 in FIG. 8B) executed on the touch cover 13 for the operation of the second box which is outside the first box (step 26); and substantially centering the second box on the panel 11 in response to the detected second gesture (step 27). The second gesture and the first gesture can be the same type of the gesture.

In some embodiments, as shown in FIG. 9C, the process includes: detecting the sliding gesture (such as the gesture 3937 or 3939 in FIG. 8B) executed on the touch cover 13 for the operation of the panel 11 (step 28); and translating the displayed part of the structured electronic document on the panel 11 in response to the detected sliding gesture (step 29). The step of translating the displayed part of the structured electronic document includes the vertical, horizontal or oblique movement of the structured electronic document on the panel 11 (step 291). Moreover, the sliding gesture also can be generated by the finger or stylus. In some embodiments, the process includes: detecting the third gesture (such as the multi-touch rotation gestures 3941 and 3943 in FIG. 8B) executed on the touch cover 13 for the operation of the panel 11 (step 30); and rotating the displayed part of the structured electronic document for 90 degrees on the panel 11 in response to the detected third gesture (step 31, as shown in FIG. 8C). The third gesture can be a twisting gesture.

In some embodiments, the process includes: detecting the variation of the position of the hand-held electronic device 1 (step 32); and rotating the displayed part of the structured electronic document on the panel 11 for 90 degrees in response to the detected variation of the position (step 33). Besides, in some embodiments, the process includes: detecting the multi-finger open/close gesture (such as the multi-finger open/close gestures 3931 and 3933 in FIG. 8B) executed on the touch cover 13 for the operation of the panel 11 (step 34); and enlarging a part of the displayed part of the structured electronic document on the panel 11 in response to the detected multi-finger open/close gesture and according to the position and finger movement of the multi-finger open/close gesture (step 35).

Summarily, in the shadeless touch hand-held electronic device and touch cover thereof according to the invention, the user can execute the touch operation on the touch cover of the shadeless touch hand-held electronic device, so the finger of the user can't shade the view or the software object displayed by the panel, and also the touch for opening the link of the high information density image won't be erroneously executed. Besides, since the operation of the electronic device is executed on the touch cover, the panel scratch situation can be reduced. Furthermore, because the user can execute the touch operation on the touch cover, the user can use multiple fingers such as the forefinger and middle finger to operate the electronic device while using the same hand holding the device. In comparison with the conventional art where the user just can use the thumb to execute the operation while using the same hand holding the device, this invention can provide more manual efficiency and convenience and can realize a better user experience.

In one embodiment, the shadeless touch hand-held electronic device is used in the strong light environment such as the outdoor sunlight or indoor high-illuminance light, the user can operate the shadeless touch hand-held electronic device in a single hand while the touch cover faces the light source of the strong light environment (or the panel faces the user) and the panel's back faces the light source of the strong light environment, so the touch cover can shade the light source. Thereby, the visibility can be enhanced and the user can continue the single-hand operation. Furthermore, the user can hold the device with a single hand and also execute the input operation with the forefinger and/or middle finger, so as to enhance the single-hand operation performance of the shadeless touch hand-held electronic device under the strong light source (such as the sunlight). Besides, in comparison with the conventional art where just the thumb can be used in the single-hand operation, the operation on the touch cover by the forefinger or middle finger can provide more flexibility and a new user experience about the single-hand holding and multi-finger touch operation.

Additionally, on the premise that the trigger quantity distribution, trigger time, trigger frequency, trigger morphology or trigger location conforms to the activation judgment condition, the hand-held electronic device just can permit the touch cover to receive at least an input action inputted by the user so as to correspondingly enlarge and substantially center the first box of the content boxes of the structured electronic document on the panel. Therefore, when other users want to operate the hand-held electronic device, they won't be permitted to operate the hand-held electronic device because the trigger event including the trigger quantity distribution, trigger time, trigger frequency, trigger morphology or trigger location doesn't conform to the activation judgment condition set by the original user, and therefore the information security of the hand-held electronic device can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A computer-implemented method executed by a shadeless touch hand-held electronic device comprising a panel and a touch cover, following steps of:
computing a trigger event of a plurality of detection points on the touch cover;
comparing the trigger event with an activation judgment condition which is pre-stored in the shadeless touch hand-held electronic device;
permitting the touch cover to receive at least an input action inputted by a user if the trigger event conforms to the activation judgment condition; and
executing an operation corresponding to the input action;
wherein the operation comprises enlarging and substantially centering a first box of a plurality of content boxes of a structured electronic document on the panel, and the enlargement comprises extending the first box such that a width of the first box is substantially equal to that of the panel.

2. The method as recited in claim 1, wherein the input action comprises a first gesture executed on the touch cover for a displayed part of the structured electronic document and the operation further comprises steps of:
detecting the first gesture;
determining the first box of the content boxes on the position corresponding to the first gesture; and
adjusting to enlarge the text size of the first box as equaling or exceeding a predetermined minimum text size of the panel.

3. The method as recited in claim 2, wherein the operation further comprises steps of:
detecting a second gesture executed on the touch cover for a second box which is outside of the first box; and
centering the second box on the panel in response to the detected second gesture.

4. The method as recited in claim 1, wherein the step of adjusting to enlarge the text size of the first box comprises steps of:
determining a scaling factor which is used to enlarge the first box;
dividing a predetermined minimum text size of the panel by the scaling factor to determine the minimum text size of the text of the first box; and
at least increasing the text size of the text of the first box to the determined minimum text size if the text size of the text of the first box is less than the predetermined minimum text size.

5. The method as recited in claim 1, further comprising steps of:
detecting a sliding gesture executed on the touch cover for the operation of the panel; and
translating a displayed part of the structured electronic document on the panel in response to the detected sliding gesture.

6. The method as recited in claim 1, wherein the trigger event comprises a trigger quantity distribution, a trigger time, a trigger frequency, a trigger morphology or a trigger location.

7. The method as recited in claim 1, wherein the user operates the shadeless touch hand-held electronic device with a single hand, and the touch cover faces a light source or the panel's back faces the light source.

8. A shadeless touch hand-held electronic device, comprising:
a panel;
a touch cover;
at least one processor;
a memory; and
at least one program stored in the memory and configured to be executed by the processor,
wherein the program comprises:
computing a trigger event of a plurality of detection points on the touch cover;
comparing the trigger event with an activation judgment condition which is pre-stored in the shadeless touch hand-held electronic device;
permitting the touch cover to receive at least an input action inputted by a user if the trigger event conforms to the activation judgment condition; and
executing an operation corresponding to the input action;
wherein the operation comprises enlarging and substantially centering a first box of a plurality of content boxes of a structured electronic document on the panel, and the enlargement comprises extending the first box such that a width of the first box is substantially equal to that of the panel.

9. The shadeless touch hand-held electronic device as recited in claim 8, wherein the input action comprises a first gesture executed on the touch cover for a displayed part of the structured electronic document and the operation further comprises steps of:
detecting the first gesture;
determining the first box of the content boxes which is on the position corresponding to the first gesture; and
adjusting to enlarge the text size of the first box as equaling or exceeding a predetermined minimum text size of the panel.

10. The shadeless touch hand-held electronic device as recited in claim 8, wherein the trigger event comprises a trigger quantity distribution, a trigger time, a trigger frequency, a trigger morphology or a trigger location.

11. The shadeless touch hand-held electronic device as recited in claim 10, wherein the program further comprises:
computing the trigger quantity distribution, trigger time, trigger frequency, trigger morphology or trigger location of the detection points at predetermined time intervals.

12. The shadeless touch hand-held electronic device as recited in claim 8, wherein the touch cover comprises:
a cover disposed on the side of the hand-held electronic device against the panel and comprising a cover body; and
a touch sensing structure, wherein partial or whole area of the touch sensing structure is disposed on the cover body, the touch sensing structure is electrically connected with the processor so that the user can operate the hand-held electronic device by the touch cover, the touch sensing structure comprises a plurality of detection points for producing an input position, the area of the touch sensing structure and the area of the panel have a ratio relationship, the processor converts the input position into the display position of the panel according to the ratio relationship, and the panel shows a notable sign at the display position.

13. The shadeless touch hand-held electronic device as recited in claim 12, wherein the touch sensing structure comprises metal mesh, metal nanowires, transparent conducting film, carbon nanotube or graphene.

14. The shadeless touch hand-held electronic device as recited in claim 12, wherein the cover further comprises a sidewall extended from at least a part of the edge of the cover body, and the touch sensing structure is further extended to be disposed on at least one of the sidewall.

15. The shadeless touch hand-held electronic device as recited in claim 12, wherein the touch sensing structure comprises:
a first sensing layer comprising a plurality of first sensing lines disposed along a first direction;
a second sensing layer disposed opposite the first sensing layer and comprising a plurality of second sensing lines disposed along a second direction, wherein the first sensing lines and the second sensing lines cross each other to form the detection points; and
a capacitance detection unit coupled with the touch sensing structure to detect the change of the coupling capacitance between the first sensing lines and the second sensing lines.

16. The shadeless touch hand-held electronic device as recited in claim 15, wherein the first sensing layer or the second sensing layer is capable of a wireless power transmission.

17. The shadeless touch hand-held electronic device as recited in claim 8, further comprising:
an eyeball tracking module acquiring an eyeball information which, corresponding to the panel, comprises a position information which corresponds to the structured electronic document displayed by the panel.

18. The shadeless touch hand-held electronic device as recited in claim 8, further comprising:
a near field communication unit comprising a near field communication chip and an antenna, wherein the near field communication chip is electrically connected with the processor and the antenna is disposed on the touch cover.

19. The shadeless touch hand-held electronic device as recited in claim 8, wherein the user operates the shadeless touch hand-held electronic device with a single hand, and the touch cover faces a light source or the panel's back faces the light source.

20. A graphical user interface of a shadeless touch hand-held electronic device which comprises a panel and a touch cover, comprising:
at least a part of a structured electronic document comprising a plurality of content boxes,
wherein a trigger event of a plurality of detection points on the touch cover is computed, the trigger event is compared with an activation judgment condition which is pre-stored in the shadeless touch hand-held electronic device, if the trigger event conforms to the activation judgment condition, the panel displays the structured electronic document and the touch cover is permitted to receive at least an input action inputted by a user, an operation corresponding to the input action is executed, the operation comprises enlarging and substantially centering a first box of the content boxes of the structured electronic document on the panel, and the enlargement comprises extending the first box such that a width of the first box is substantially equal to that of the panel.
